(19) United States
(12) Patent Application Publication
(10) Pub. No.: US 2005/0168641 A1
(43) Pub. Date: Aug. 4, 2005

(54) Broadcast transceiver and method of operating tuner thereof

(76) Inventor: Dong-Uk Seo, Cheonan-si (KR)

Correspondence Address: Robert E. Bushnell, Suite 300, 1522 K Street, N.W., Washington, DC, 20005-1202, US

(21) Appl. No.: 11/004,826

(22) Filed: Dec. 7, 2004

(30) Foreign Application Priority Data
Jan. 30, 2004 (KR) 2004-6308

(51) Int. Cl. H04N 5/44

(52) U.S. Cl. 348/565; 348/731

(57) ABSTRACT

A method of operating a tuner of a broadcast transceiver having a first tuner and a second tuner adapted to tune both analog and digital broadcasts includes: arranging a broadcast transceiver to include first and second tuners each adapted to tune both analog and digital broadcasts; determining which of the first and second tuners is tuned to a currently playing broadcast and setting that tuner as a primary tuner in response to a command for performing one of PIP and PVR functions being inputted by a user; setting the other of the first and second tuners as a secondary tuner and waiting for channel setting information from the user; and determining a broadcast scheme of the corresponding channel and designating an operational mode of the secondary tuner as the broadcast scheme of the corresponding channel in response to the channel setting information being inputted by the user.

### CLAIM OF PRIORITY

This application makes reference to, incorporates the same herein, and claims all benefits accruing under 35 U.S.C. § 119 from an application for METHOD FOR OPERATING TUNER OF BROADCASTING TRANSCEIVER AND THE SAME earlier filed in the Korean Intellectual Property Office on 30 Jan. 2004 and there duly assigned Serial No. 2004-6308.

### BACKGROUND OF THE INVENTION

1. Field of the Invention

The present invention relates to a broadcast transceiver and a method of operating a tuner thereof. More specifically, the present invention relates to a method of operating tuners of analog and digital broadcast transceivers and to a method of operating a broadcast tuner capable of receiving and tuning both analog and digital broadcast signals to perform a Picture In Picture (PIP) or Personal Video Recorder (PVR) function.

2. Description of the Related Art

In PIP technology, high-frequency signals of a plurality of desired channels are selected by a main tuner and a sub tuner from among a plurality of high frequency signals received from an antenna in a broadcast transceiver, such as a television set or a set-top box, in either analog broadcast or cable broadcast, and high-frequency signals are converted and modulated into intermediate frequency signals to display a plurality of scenes on a television screen.

Meanwhile, the PVR technology, which replaces an existing video tape recorder with a hard disk, makes it possible to watch real-time broadcast in a still mode in combination with digital technology and to play back a missed scene. This is because there exists a function of recording the broadcast to the hard disk in real-time and playing it again. For this reason, if there is a phone call while watching TV, a viewer can temporarily stop the television scene and watch it again several minutes later than real-time until the end of the show.

Conventionally, in analog broadcast or cable broadcast, a main tuner (for primary broadcast) and a sub tuner (for PIP or PVR) is employed for implementing the PIP or PVR function in a broadcast transceiver, such as the television set or set-top box.

### SUMMARY OF THE INVENTION

It is, therefore, an object of the present invention to provide a broadcast transceiver and a tuner of the broadcast transceiver adapted to perform a PIP or PVR function by effectively using the tuner in the broadcast transceiver.

To accomplish the above-noted object, according to one aspect of the present invention, a method is provided comprising: arranging a broadcast transceiver to include first and second tuners each adapted to tune both analog and digital broadcasts; determining which of the first and second tuners is tuned to a currently playing broadcast and setting that tuner as a primary tuner in response to a command for performing one of PIP and PVR functions being inputted by a user; setting the other of the first and second tuners as a secondary tuner and waiting for channel setting information from the user; and determining a broadcast scheme of the corresponding channel and designating an operational mode of the secondary tuner as the broadcast scheme of the corresponding channel in response to the channel setting information being inputted by the user.

The method can further comprise: transmitting frequency information of the corresponding channel in response to the secondary tuner being designated as the secondary tuner and tuning the secondary tuner to a broadcast signal of the corresponding frequency.

The method can further comprise: setting the tuner that tunes a remaining unblocked broadcast signal as the primary tuner in response to one of the broadcast signal tuned by the primary tuner and the broadcast signal tuned by the secondary tuner being blocked.

The method can further comprise outputting the broadcast signal tuned by the secondary tuner as a broadcast signal for the PIP function and PVR function.

The method can further comprise performing the operational mode such that both the primary and secondary tuners tune an analog broadcast signal.

The method can further comprise performing the operational mode such that the primary tuner tunes an analog broadcast signal and the secondary tuner tunes a digital broadcast signal.

The method can further comprise performing the operational mode such that the primary tuner tunes a digital broadcast signal and the secondary tuner tunes an analog broadcast signal.

The method can further comprise performing the operational mode such that both the primary and secondary tuners tune a digital broadcast signal.

According to another aspect of the present invention, a broadcast transceiver is provided comprising: first and second tuners each adapted to tune both analog broadcast and digital broadcasts: and a tuner operation processor adapted to:

determine that a tuner is tuned to a currently playing broadcast and setting that tuner as a primary tuner; set the other of the first and second tuners as a secondary tuner and wait for channel setting information from the user in response to a command for performing one of PIP and PVR functions being inputted by a user; and determine a broadcast scheme of the corresponding channel and designate an operational mode of the secondary tuner as the broadcast scheme of the corresponding channel in response to the channel setting information being inputted by the user.

The tuner operation processor can be adapted to transmit frequency information of the corresponding channel in response to the secondary tuner being designated as the secondary tuner and tune the secondary tuner to a broadcast signal of the corresponding frequency.

The tuner operation processor can be adapted to set the tuner that tunes a remaining unblocked broadcast signal as the primary tuner in response to one of the broadcast signal tuned by the primary tuner and the broadcast signal tuned by the secondary tuner being blocked.

The tuner operation processor can be adapted to output the broadcast signal tuned by the secondary tuner as a broadcast signal for the PIP and PVR functions.

The tuner operation processor can be adapted to perform the operational mode such that the primary tuner and the secondary tuner tune analog broadcast signals.

The tuner operation processor can be adapted to perform the operational mode such that the primary tuner tunes an analog broadcast signal and the secondary tuner tunes a digital broadcast signal.

The tuner operation processor can be adapted to perform the operational mode such that the primary tuner tunes a digital broadcast signal and the secondary tuner tunes an analog broadcast signal.

The tuner operation processor can be adapted to perform the operational mode such that the primary tuner and the secondary tuner tune digital broadcast signals.

### BRIEF DESCRIPTION OF THE DRAWINGS

A more complete appreciation of the present invention, and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a block diagram of a PIP tuner of an analog broadcast transceiver;

FIG. 2 is a block diagram of a PIP tuner that receives analog broadcast and digital broadcast;

FIG. 3 is a block diagram of a broadcast transceiver having an analog tuner and a digital tuner according to an embodiment of the present invention; and

FIG. 4 is a flowchart of a method of designating a broadcast tuning mode in each tuner using the matrix of Table 2.

### DETAILED DESCRIPTION OF THE INVENTION

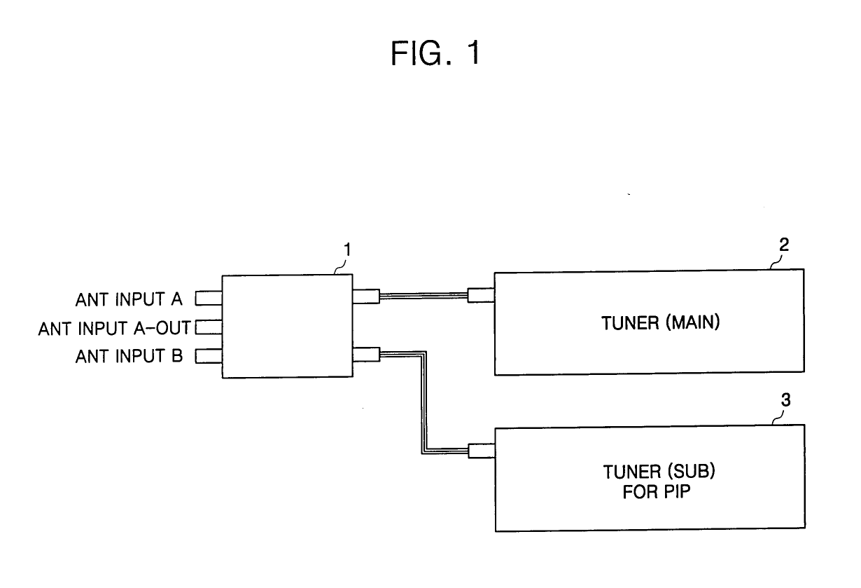

FIG. 1 is a block diagram of a PIP tuner of an analog broadcast transceiver.

Referring to FIG. 1, the PIP tuner of the analog broadcast transceiver includes: a splitter 1 for splitting a plurality of high frequency signals received from an antenna (ANT); a main tuner 2 for selecting only high-frequency signals of a main desired channel from among the plurality of high frequency signals split by the splitter 1 to convert and amplify the high-frequency signals of the main desired channel into intermediate frequency signals; and a sub tuner 3 for selecting only high-frequency signals of a desired sub channel from among the plurality of high frequency signals split by the splitter 1 to convert and amplify the high-frequency signals of the desired sub channel into intermediate frequency signals.

The main tuner 2, though not shown, can include: a main input filter for removing an unnecessary noise component included in the high frequency signal split by the splitter 1; a main input tuner for performing a first tuning of the high frequency signals filtered by the main input filter; a main high frequency amplifier for amplifying the high frequency signal tuned by the main input tuner; a main inter-stage tuner for performing second fine-tuning of the high frequency signal amplified by the main high frequency amplifier; a main mixer for mixing the high frequency signal of the main inter-stage tuner and an oscillating frequency signal of a main local oscillator to generate intermediate frequency signals; and a main intermediate frequency amplifier for amplifying and outputting the intermediate frequency signal of the main mixer.

Furthermore, the sub tuner 2, though not shown, can include: a sub input filter for removing an unnecessary noise component included in the high frequency signal split by the splitter 1; a sub input tuner for performing a first tuning of the high frequency signals filtered by the sub input filter; a sub high frequency amplifier for amplifying the high frequency signal tuned by the sub input tuning; a sub inter-stage tuner for performing a second fine-tuning of the high frequency signal amplified by the sub high frequency amplifying; a sub mixer for mixing the high frequency signal of the sub inter-stage tuner and an oscillating frequency signal of a sub local oscillator to convert the high frequency signal into an intermediate frequency signal; and a sub intermediate frequency amplifier for amplifying and outputting the intermediate frequency signal of the sub mixer.

When the plurality of high frequency signals are received and outputted by the antenna (ANT), a splitter 1 splits the plurality of high frequency signals and supplies the split plurality of high frequency signals to a main tuner 2 and a sub tuner 3.

The high frequency signal supplied to the main tuner 2 is filtered by the main input filter, and then is first-tuned by the main input tuner and supplied to the main high frequency amplifier.

The high frequency signal amplified by the main high frequency amplifier is secondly fine-tuned by the main inter-stage tuner, and in the main mixer, is mixed with the oscillating frequency signal of the main local oscillating unit and then the tuned high frequency signal is converted into an intermediate frequency signal, and this intermediate frequency signal is maximally amplified again by the main intermediate frequency amplifier and is demodulated in a demodulator of the back end to be displayed as a main scene on a television screen.

The high frequency signal supplied to the sub tuner 2 is filtered by the sub input filter, and then is first-tuned by the sub input tuner and supplied to the sub high frequency amplifier.

The high frequency signal amplified by the sub high frequency amplifier is secondly fine-tuned by the sub inter-stage tuner, and in the sub mixer, is mixed with the oscillating frequency signal of the sub local oscillating unit and then converted into an intermediate frequency signal, and this intermediate frequency signal is maximally amplified again by the sub intermediate frequency amplifier and is demodulated in a demodulator of the back end to be displayed as a sub scene on a television screen.

As the digital broadcast service begins, the number of channels of digital and analog broadcast transmitted through terrestrial, cable, and satellite, etc., wil increase to more than 100.

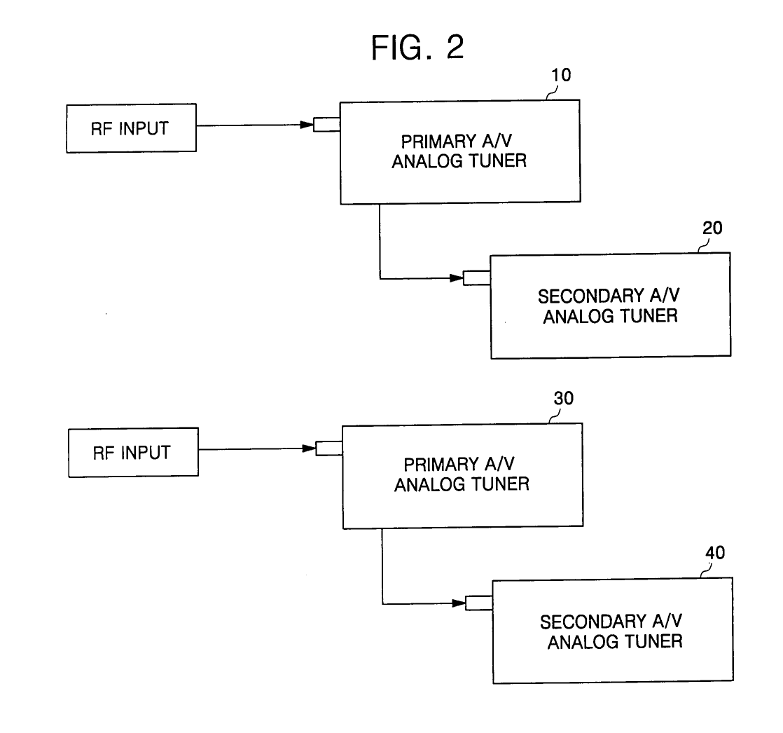

FIG. 2 is a block diagram of a PIP tuner of a broadcast transceiver that receives analog broadcast and digital broadcast.

Referring to FIG. 2, the PIP tuner comprises a main tuner for analog broadcast 10 and a sub tuner for analog broadcast 20 to receive analog broadcasts, and a main tuner for digital broadcast 30 and a sub tuner for digital broadcast 40 to receive digital broadcasts.

One tuner can tune only one broadcast frequency, and a tuner for receiving analog broadcasts and a tuner for receiving digital broadcasts cannot be shared. Previously, under multi-channel broadcast, a broadcast transceiver can only be manufactured by arranging two tuners for analog broadcasts and two tuners for digital broadcasts, as shown above, for simultaneously performing a PIP function in both analog and digital broadcasts.

An RF input can directly connect the antenna or the cable to the tuner, or split the antenna or the cable to the tuner using the RF splitter.

Table 1 shows a watcher mode and tuner selection using the PIP function in the broadcast transceiver with the structure discussed above.

TABLE 1

| | PIP(PVR) watcher mode | Tuner selection |
|---|---|---|
| 1 | Perform PIP(PVR) of analog broadcast while | Analog tuner #1 |
| | watching analog broadcast | Analog tuner #2 |
| 2 | Perform PIP(PVR) of digital broadcast while | Analog tuner |
| | watching analog broadcast | Digital tuner |
| 3 | Perform PIP(PVR) of analog broadcast while | Analog tuner |
| | watching digital broadcast | Digital tuner |
| 4 | Perform PIP(PVR) of digital broadcast while | Digital tuner #1 |
| | watching digital broadcast | Digital tuner #2 |

Referring to Table 1, to perform the PIP function of an analog broadcast while watching an analog broadcast, an analog tuner #1 10 and an analog tuner #2 20 are activated.

To perform the PIP function of a digital broadcast while watching an analog broadcast, the analog tuner 10 or 20 and a digital tuner 30 or 40 are activated.

To perform the PIP function of an analog broadcast while watching a digital broadcast, the digital tuner 30 or 40 and the analog tuner 10 or 20 are activated.

To perform the PIP function of a digital broadcast while watching a digital broadcast, the digital tuner #1 30 and the digital tuner #2 40 are activated.

However, having four tuners in one broadcast transceiver causes a problem in that the broadcast transceiver size is both large and costly.

A multi-channel broadcast environment where analog and digital broadcasts are mixed is increasing rapidly and tuners capable of switching and tuning both the analog signal and digital signals are being developed in many ways.

The present invention will now be described more fully hereinafter with reference to the accompanying drawings, in which an embodiment of the present invention is shown. The present invention may, however, be embodied in different forms and should not be construed 11 as being limited to the embodiment set forth herein. Rather, the embodiment has been provided so that this disclosure will be thorough and complete, and will fully convey the scope of the present invention to those skilled in the art. Like numbers refer to like elements throughout the specification.

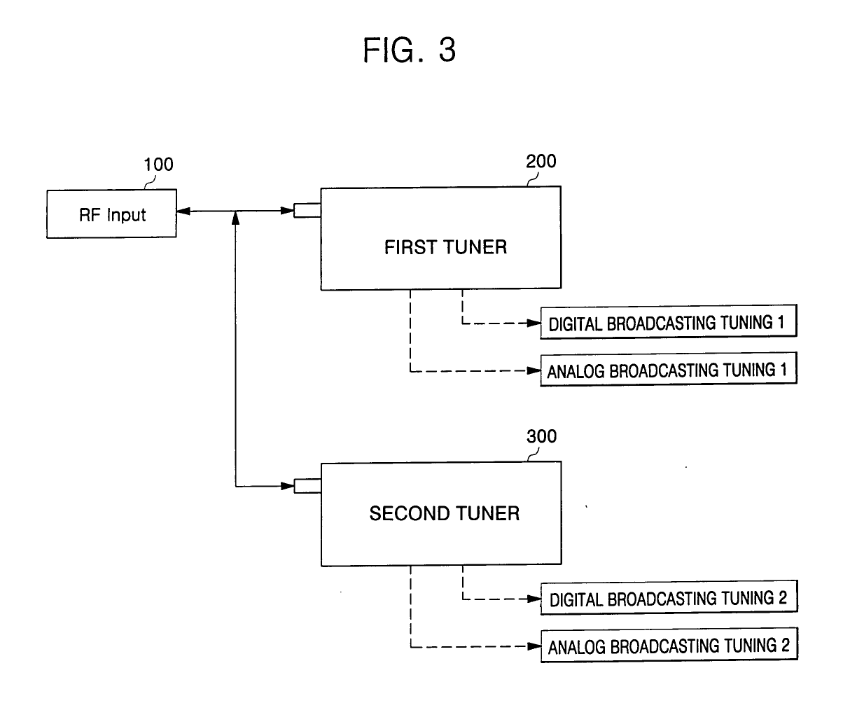

FIG. 3 is a block diagram of a broadcast transceiver having an analog tuner and a digital tuner according to an embodiment of the present invention.

Referring to FIG. 3, the broadcast transceiver according to an embodiment of the present invention includes a first tuner 200 and a second tuner 300 that selectively tune either analog or digital broadcasts in accordance with a watcher mode for the broadcast signal inputted through an RF signal processor 100 and conform to the specification of the broadcast transceiver to output a PIP or PVR function.

An RF input 100 outputs the broadcast signal transmitted via an antenna or a cable network to both tuner 200 and tuner 300 for receiving both analog and digital broadcasts. The RF input 100 can split the RF signal with a splitter, and output the RF signal to the second tuner by adding a Loop through function to the tuner itself.

The first tuner 200 and the second tuner 300 can each tune either digital or analog broadcasts. That is, as the tuner technology is progressed, a watcher can watch a broadcast with just one tuner by selecting either an analog or digital broadcast. However, two broadcasts cannot be simultaneously tuned with just one tuner.

The first tuner 200 and the second tuner 300 can be selected to tune an analog or digital broadcast at every moment that the watcher wants to tune.

Furthermore, each tuner can perform the PIP or PVR function, by selectively tuning either an analog broadcast or a digital broadcast according to the watcher mode to conform to the specification of the broadcast transceiver.

The present invention designates each tuner's operation using a matrix, while operating the first tuner 200 and the second tuner 300 in order to perform the PIP function or PVR function for both analog and digital broadcasts.

The following patents each discloses features in common with the present invention but do not teach or suggest the inventive features specifically recited in the present claims:

TABLE 2

| | PIP watcher mode | Tuner selection |
|---|---|---|
| 1 | Perform PIP(PVR) of analog broadcast while | First tuner -analog |
| | watching analog broadcast | Second tuner -analog |
| 2 | Perform PIP(PVR) of digital broadcast while | First tuner -analog |
| | watching analog broadcast | Second tuner -digital |
| 3 | Perform PIP(PVR) of analog broadcast while | First tuner -digital |
| | watching digital broadcast | Second tuner -analog |
| 4 | Perform PIP(PVR) of digital broadcast while | First tuner -digital |
| | watching digital broadcast | Second tuner -digital |

Table 2 indicates that a mode of the first tuner 200 and the second tuner 300 is designated using the matrix to perform the PIP or PVR function for both the analog and digital broadcasts.

As shown in Table 2, each mode of the first tuner 200 and the second tuner 300 can be set using the matrix to perform the PIP or PVR function for both the analog and digital broadcasts.

Referring to Table 2, the tuning modes of the first tuner 200 and the second tuner 300 can be classified into four types of broadcast tuning.

First, in performing the PIP function for an analog broadcast while watching an analog broadcast, an operation mode of each tuner is set such that the first tuner 200 tunes and outputs an analog broadcast, and the second tuner 300 also tunes and outputs an analog broadcast.

Second, in performing the PIP function for a digital broadcast while watching an analog broadcast, the operation mode of each tuner is set such that the first tuner 200 tunes and outputs an analog broadcast, and the second tuner 300 tunes and outputs a digital broadcast.

Third, in performing the PIP function for an analog broadcast while watching a digital broadcast, the operation mode of each tuner is set such that the first tuner 200 tunes and outputs a digital broadcast, and the second tuner 300 tunes and outputs an analog broadcast.

Fourth, in performing the PIP function for a digital broadcast while watching a digital broadcast, the operation mode of each tuner is set such that the first tuner 200 tunes and outputs a digital broadcast, and the second tuner 300 also tunes and outputs a digital broadcast. Table 3 is an example of allocation of cable TV frequencies.

TABLE 3

| | Channel | Frequency | Broadcast scheme |
|---|---|---|---|
| 1 | Ch 6 | 85 MHz | Analog SBS |
| 2 | Ch 7 | 177 MHz | Analog KBS2 |
| 3 | Ch 9 | 189 MHz | Analog KBS1 |
| 4 | Ch 11 | 201 MHz | Analog MBC |
| 5 | Ch 21 | 453 MHz | Digital |
| 6 | Ch 23 | 699 MHz | Digital |

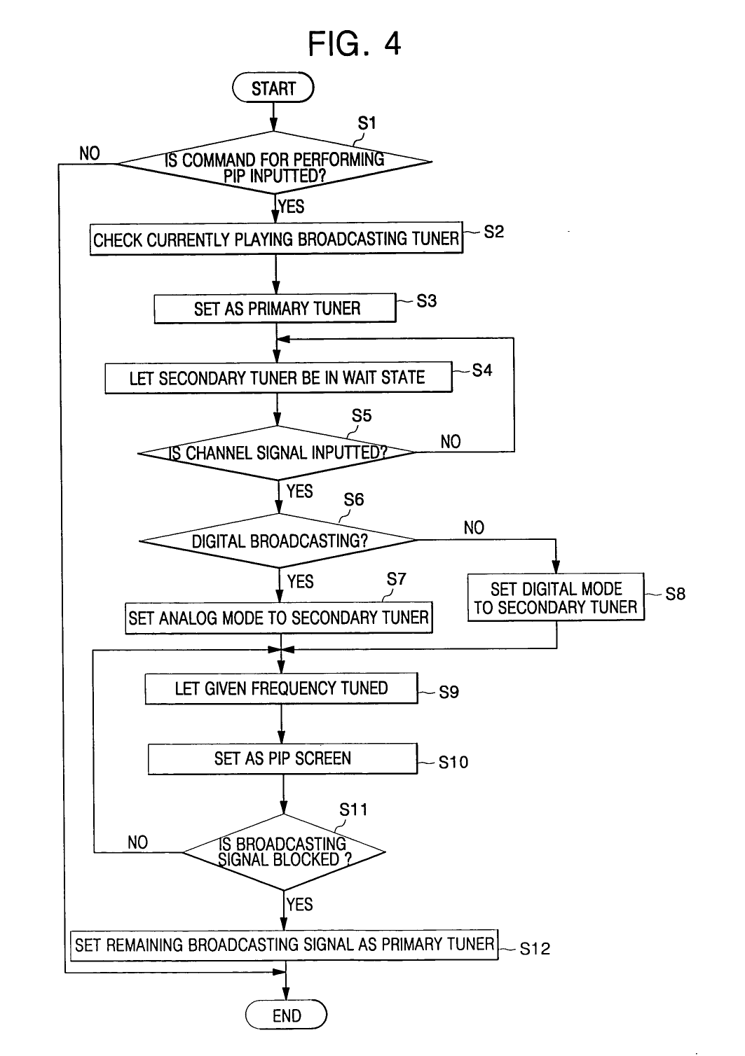

FIG. 4 is a flowchart of a method of designating a broadcast tuning mode in each tuner using the matrix shown in Table 2.

A procedure of operating the tuner for broadcast tuning is explained with reference to FIG. 4 and Table 3.

First, a determination is made as to whether or not a command for performing a PIP function has been inputted from a user (S1). If so, a tuner that is currently playing a broadcast to perform the PIP function is checked (S2). For example, when channel 6 is on the air and is being tuned by the first tuner 200, the first tuner 200 becomes the currently operating tuner. If the currently operating tuner is checked, that tuner is set as a primary tuner (S3). Since the first tuner 200 becomes the primary tuner, the second tuner 300 becomes the secondary tuner to wait for the input of a channel setting signal of the user (S4). While the second tuner 300 is waiting for the input of the channel setting signal from the user, a determination is made as to whether or not a channel signal has been inputted (S5). If a channel signal has been inputted from the user while the secondary tuner is waiting, a determination is made as to whether a given channel 11 is an analog or digital broadcast (S6). As a result of the determination, if the given channel is for a digital broadcast, the digital mode is set to the secondary tuner (S7). If not, the analog mode is set to the secondary tuner (S8). After the digital mode or the analog mode is set to the secondary tuner, frequency information of the given channel is provided to the secondary tuner to tune to the given frequency signal (S9). The broadcast tuned by the secondary tuner is set as a broadcast to be played on the PIP screen (S10).

In the mean time, while the broadcast signal tuned by the primary tuner and the broadcast signal tuned by the secondary tuner are outputted, if one of them is blocked, then the tuner that tunes the remaining broadcast signal is set as the primary tuner (S11, S12).

Although the method of operating each tuner in performing the PIP function has been described in the foregoing embodiments, the present invention is not limited to performing the PIP function, but can also configure the operation mode of each tuner with a matrix in implementing a PVR function as illustrated above, thereby improving the operational efficiency of the broadcast transceiver.

According to the present invention, under the multi-channel broadcast environment where analog and digital broadcasts are mixed, two processable tuners of both analog and digital broadcasts can be effectively operated to perform the PIP function or PVR function.

With this, the complexity of the broadcast transceiver where four tuners are employed to implement the PIP function or PVR function is reduced, thereby reducing the PCB size and cost.

1. A method comprising:
arranging a broadcast transceiver to include first and second tuners each adapted to tune both analog and digital broadcasts;
determining which of the first and second tuners is tuned to a currently playing broadcast and setting that tuner as a primary tuner in response to a command for performing one of PIP and PVR functions being inputted by a user;
setting the other of the first and second tuners as a secondary tuner and waiting for channel setting information from the user; and
determining a broadcast scheme of the corresponding channel and designating an operational mode of the secondary tuner as the broadcast scheme of the corresponding channel 11 in response to the channel setting information being inputted by the user.

2. The method according to claim 1, further comprising:
transmitting frequency information of the corresponding channel in response to the secondary tuner being designated as the secondary tuner and tuning the secondary tuner to a broadcast signal of the corresponding frequency.

3. The method according to claim 1, further comprising:
setting the tuner that tunes a remaining unblocked broadcast signal as the primary tuner in response to one of the broadcast signal tuned by the primary tuner and the broadcast signal tuned by the secondary tuner being blocked.

4. The method according to claim 1, further comprising outputting the broadcast signal tuned by the secondary tuner as a broadcast signal for the PIP function or PVR function.

5. The method according to claim 1, further comprising performing the operational mode such that both the primary and secondary tuners tune an analog broadcast signal.

6. The method according to claim 1, further comprising performing the operational mode such that the primary tuner tunes an analog broadcast signal and the secondary tuner tunes a digital broadcast signal.

7. The method according to claim 1, further comprising performing the operational mode such that the primary tuner tunes a digital broadcast signal and the secondary tuner tunes an analog broadcast signal.

8. The method according to claim 1, further comprising performing the operational mode such that both the primary and secondary tuners tune a digital broadcast signal.

9. A broadcast transceiver, comprising:
first and second tuners each adapted to tune both analog broadcast and digital broadcasts: and
a tuner operation processor adapted to:
determine that a tuner is tuned to a currently playing broadcast and setting that tuner as a primary tuner;
set the other of the first and second tuners as a secondary tuner and wait for channel setting information from the user in response to a command for performing one of PIP and PVR functions being inputted by a user; and
determine a broadcast scheme of the corresponding channel and designate an operational mode of the secondary tuner as the broadcast scheme of the corresponding channel in response to the channel setting information being inputted by the user.

10. The broadcast transceiver according to claim 9, wherein the tuner operation processor is adapted to transmit frequency information of the corresponding channel in response to the secondary tuner being designated as the secondary tuner and tune the secondary tuner to a broadcast signal of the corresponding frequency.

11. The broadcast transceiver according to claim 9, wherein the tuner operation processor is adapted to set the tuner that tunes a remaining unblocked broadcast signal as the primary tuner in response to one of the broadcast signal tuned by the primary tuner and the broadcast signal tuned by the secondary tuner being blocked.

12. The broadcast transceiver according to claim 9, wherein the tuner operation processor is adapted to output the broadcast signal tuned by the secondary tuner as a broadcast signal for the PIP or PVR functions.

13. The broadcast transceiver according to claim 9, wherein the tuner operation processor is adapted to perform the operational mode such that the primary tuner and the secondary tuner tune analog broadcast signals.

14. The broadcast transceiver according to claim 9, wherein the tuner operation processor is adapted to perform the operational mode such that the primary tuner tunes an analog broadcast signal and the secondary tuner tunes a digital broadcast signal.

15. The broadcast transceiver according to claim 9, wherein the tuner operation processor is adapted to perform the operational mode such that the primary tuner tunes a digital broadcast signal and the secondary tuner tunes an analog broadcast signal.

16. The broadcast transceiver according to claim 9, wherein the tuner operation processor is adapted to perform the operational mode such that the primary tuner and the secondary tuner tune digital broadcast signals.
